(19) United States
(12) Patent Application Publication
(10) Pub. No.: US 2011/0180297 A1
(43) Pub. Date: Jul. 28, 2011

(54) CABLE MANAGEMENT APPARATUS

(75) Inventors: Mo-Ming Yu, Shenzhen City (CN); Guang-Hua Gu, Shenzhen City (CN); Wen-Feng Hu, Shenzhen City (CN)

(73) Assignees: HONG FU JIN PRECISION INDUSY (ShenZhen) CO., LTD., Shenzhen City (CN); HON HAI PRECISION INDUSTRY CO., LTD., Tu-Cheng (TW)

(21) Appl. No.: 12/765,791

(22) Filed: Apr. 22, 2010

(30) Foreign Application Priority Data
Jan. 27, 2010 (CN) 201010300831.2

(51) Int. Cl. H01B 7/06

(52) U.S. Cl. 174/69

(57) ABSTRACT

A cable management apparatus is arranged between two slide assemblies, each including a first rail fixed to and equipment rack and a second rail slidably coupled to the first rail. The cable management apparatus includes a foldable arm assembly, and a supporting member. Opposite ends of the arm assembly are correspondingly connected to the first rail and the second rail of one of the sliding assemblies. The supporting member includes a supporting rail to support the arm assembly, thereby preventing the arm assembly from sagging. The supporting rail is angled to an extending direction of the sliding assemblies, with a first end of the supporting rail connected to the first rail of one of the slide assemblies, and a second end arranged behind the first end of the supporting rail and connected to the first rail of the other slide assembly.

### BACKGROUND

1. Technical Field

The present disclosure relates to cable management and, more particularly, to a cable management apparatus for a rack-mounted device.

2. Description of the Related Art

Commonly used component racks often include a pair of opposing sides to which telescoping slide assemblies are connected for slidable support of electronic devices, such as servers. Typically, multiple devices are often disposed at different vertically spaced levels in the equipment rack, usually closely adjacent to each other. Cables extend from the electronic devices for connection outside the equipment rack.

A cable management apparatus is provided for supporting cables of each of the electronic devices in the rack. The cable management apparatus often includes at least two arms pivotally connected end to end. Opposite free ends of the cable management apparatus are respectively attached to a stationary rail and a movable rail of one of the slide assemblies. Accordingly, the cable management apparatus spreads with extension of the slide assembly, and collapses with retraction. Since the cable management apparatus cantilevers from the slide assembly, sagging due to weight of the cables can occur, negatively affecting the operation of the connected electronic device.

### BRIEF DESCRIPTION OF THE DRAWINGS

FIGS. 1 and 2 are exploded, isometric views from different perspectives of an embodiment of a cable management apparatus, with two opposite slide assemblies correspondingly attached to opposite sides of an equipment rack, the cable management apparatus including an arm assembly, a first mounting bracket, a second mounting bracket, an attachment member, and a supporting member.

FIG. 3 is an enlarged view of an encircled portion III of FIG. 1

FIG. 4 is an enlarged view of the first mounting bracket, the second mounting bracket, and the attachment member.

FIG. 5 is similar to FIG. 4, but viewed from another perspective.

FIG. 6 is a cutaway view of the supporting member of FIG. 2.

FIG. 7 is an assembled view of FIG. 1.

FIGS. 8-10 are top plan views of FIG. 7, respectively showing the arm assembly fully folded, partially spread, and fully spread.

FIG. 11 is another top view of FIG. 7, showing the arm assembly swinging clockwise to open.

FIG. 12 is similar to FIG. 11, but shows the arm assembly swinging counterclockwise to open, the first mounting bracket and the second mounting bracket having been switched compared to FIG. 11.

### DETAILED DESCRIPTION

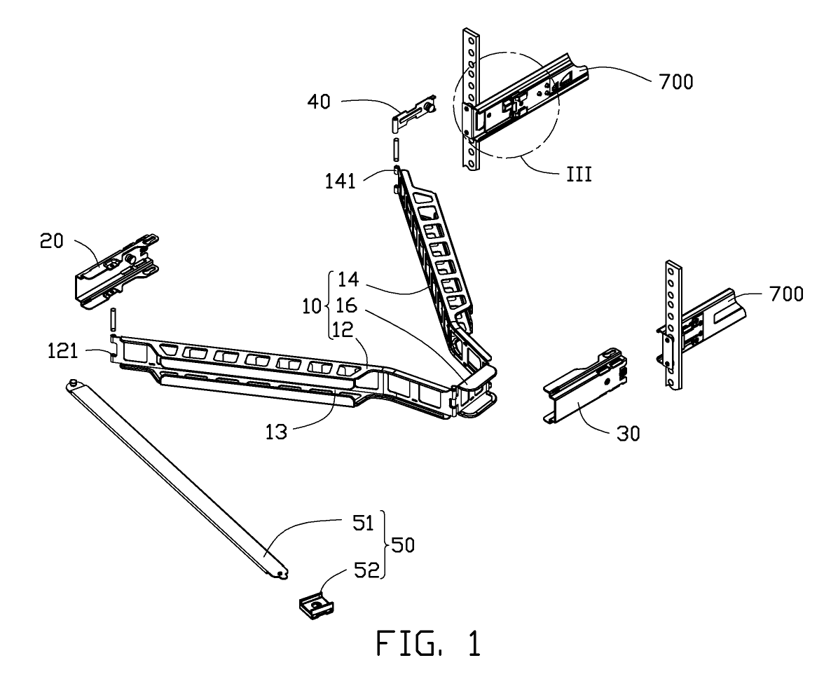

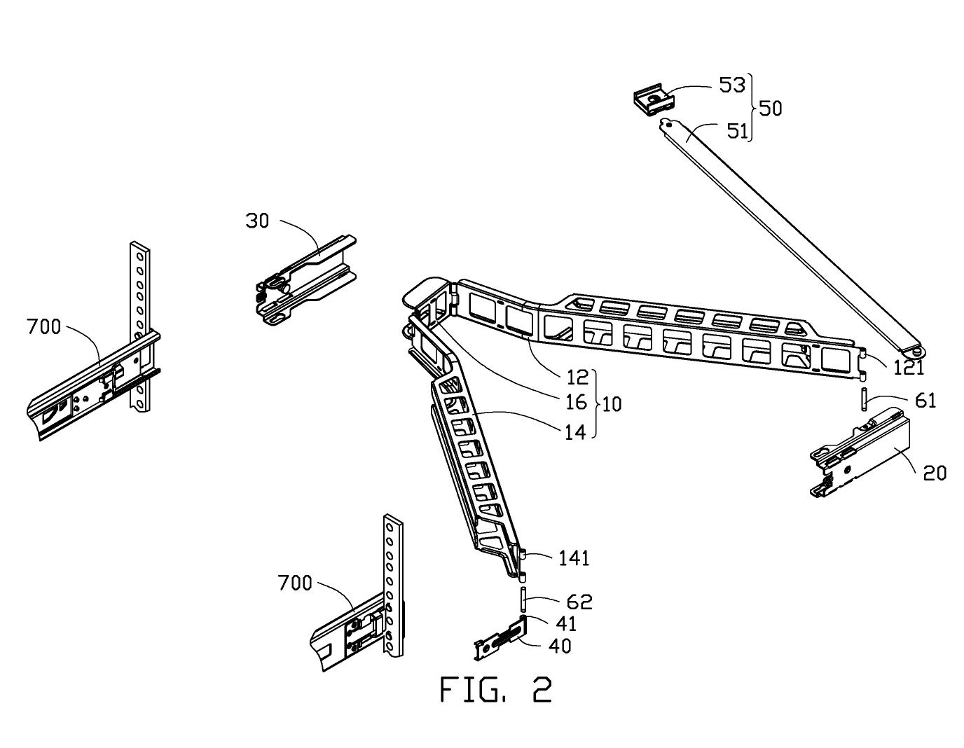

Referring to FIGS. 1 and 2, an embodiment of a cable management apparatus is provided between two opposite slide assemblies 700 to accommodate cables associated with an electronic device. The slide assemblies 700 are correspondingly attached to opposite sides of an equipment rack. The cable management apparatus includes an arm assembly 10, a first mounting bracket 20, a second mounting bracket 30, an attachment member 40, and a supporting member 50.

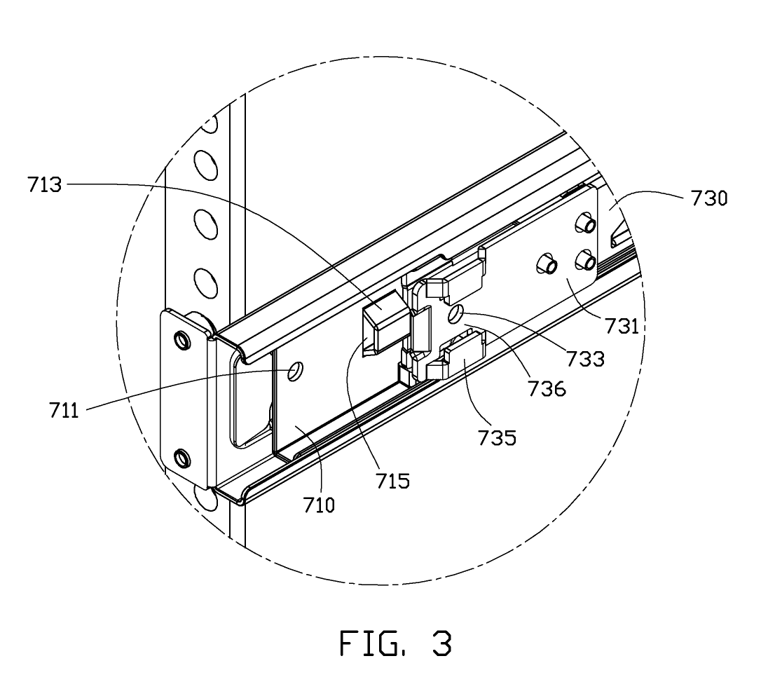

Referring to FIG. 3, each of the slide assemblies 700 includes a first rail 710. C-shaped in cross section, and a second rail 730 slidably received in the first rail 710. A locking hole 711 is defined in the first rail 710 adjacent to a rear of the first rail 710. A bow-shaped strip 713 is formed on the first rail 710 to define a retaining gap 715 between the strip 713 and first rail 710. The strip 713 is arranged adjacent to and at a front side of the locking hole 711. A fixing plate 731 is secured to a rear of the second rail 730. The fixing plate 731 forms two bow-shaped guiding blocks 735 adjacent to a rear side of the fixing plate 731, and respectively at top and bottoms of the fixing plate 731. The two guiding blocks 735 cooperatively bound a guiding slot 736. Since each of the guiding blocks 735 includes a larger middle portion and two smaller end portions at front and rear sides of the middle portion. A locking hole 733 is defined in the second rail 730 between the two guiding blocks 735.

The arm assembly 10 includes a first arm segment 12, a second arm segment 14, and a connecting member 16. Each of the first arm segment 12 and the second arm segment 14 is an elongated frame defining a cable receiving passage 13. First ends of the first arm segment 12 and the second arm segment 14 pivotally connect to opposite ends of the connecting member 16. A pivoting portion 121 and a pivoting portion 141 are respectively formed at second ends of the first arm segment 12 and the second arm segment 14, opposite to the connecting member 16.

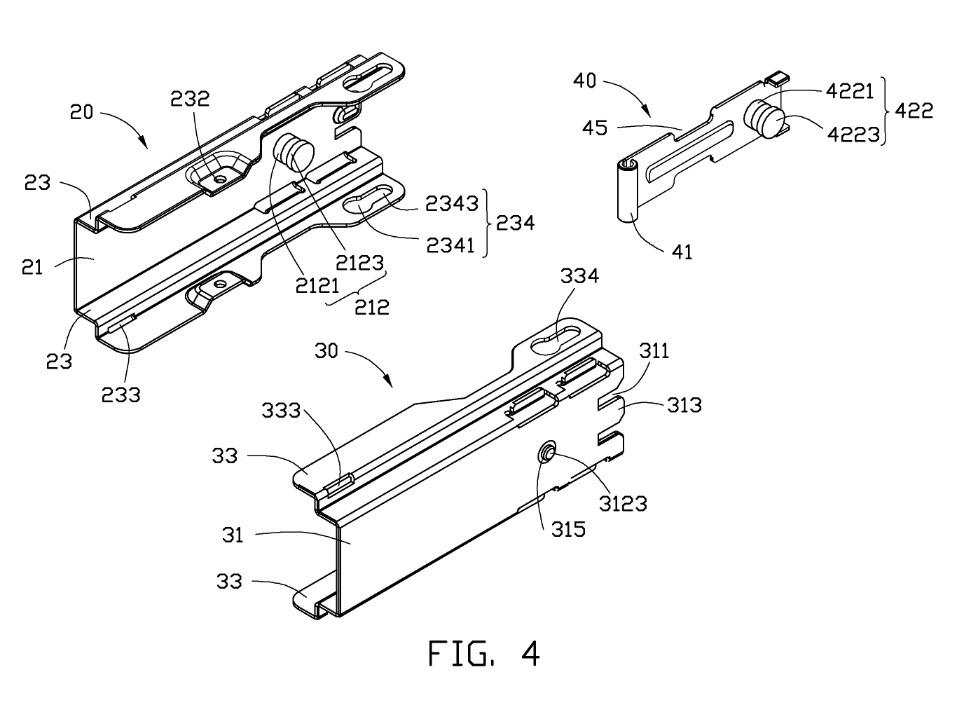

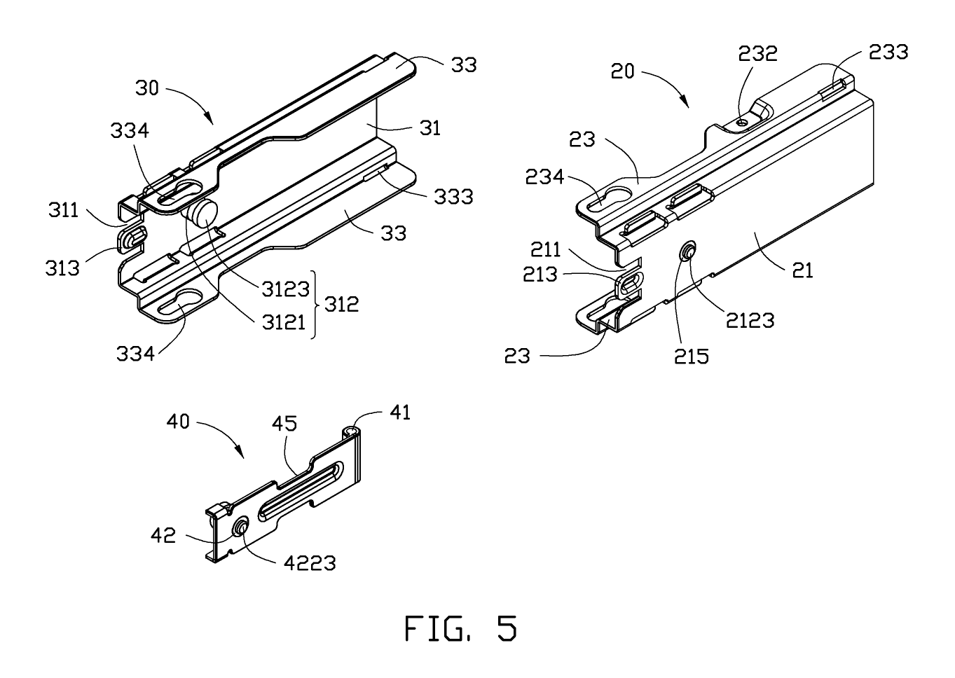

Referring to FIGS. 4 and 5, the first mounting bracket 20 includes a sidewall 21 from opposite sides of which two flanges 23 extend. Two parallel cutouts 211 are defined in a front end of the sidewall 21 with an insert 213 formed between the two cutouts 211. A through hole 215 is defined in the sidewall 21 adjacent to the cutouts 211. An engaging button 212 is mounted to the sidewall 21. The engaging button 212 includes a cylinder 2121 secured to the sidewall 21 to axially align with the through hole 215, a bolt 2123 movably received in the cylinder 2121, and a resilient means (not shown) connected between the cylinder 2121 and the bolt 2123 to force the bolt 2123 towards the sidewall 21 and extend a first end of the bolt 2123 out of through hole 215. A manipulating portion is formed on the second end of the bolt 2123. An slot 233 is defined in each of the flanges 23 adjacent to a rear of the flange 23. A pivot hole 232 is defined in a middle of each of the flanges 23. A coupling hole 234 is defined in each of the flanges 23 adjacent to a front end of the flange 23. Each of the coupling holes 34 includes a greater access portion 2341 and a smaller retaining portion 2343 communicating with the access portion 2341.

The second mounting bracket 30 is shaped and structured substantially the same as the first mounting bracket 20. The second mounting bracket 30 includes a sidewall 31 and two flanges 33 extending from opposite sides of the sidewall 31. Two parallel cutouts 311 are defined in a front end of the sidewall 31 with an insert 313 formed between the two cutouts 311. A through hole 315 is defined in the sidewall 31 adjacent to the cutouts 311. An engaging button 312 is mounted to the sidewall 31. The engaging button 312 includes a cylinder 3121 secured to the sidewall 31 to axially align with the through hole 315, a bolt 3123 movably received in the cylinder 3121, and a resilient means (not shown) connected between the cylinder 3121 and the bolt 3123 to force the bolt 3123 towards the sidewall 31 and make a first end of the bolt 3123 extend out of through hole 315. A manipulating portion is formed on a second end of the bolt 3123. A coupling hole 334 shaped the same as the coupling hole 234 is defined in each of the flanges 33 adjacent to a front end of the flange 33. An slot 333 is defined in each of the flanges 33 adjacent to a rear of the flange 33.

The attachment member 40 is a substantially rectangular piece with a pivoting portion 41 formed at a first end of the attachment member 40. A through hole 42 is defined in the attachment member 40 adjacent to a second end of the attachment member 40 opposite to the pivoting portion 41. An engaging button 422 is mounted to the attachment member 40. The engaging button 422 includes a cylinder 4221 secured to the attachment member 40 to axially align with the through hole 42, a bolt 4223 movably received in the cylinder 4221, and a resilient means (not shown) connected between the cylinder 4221 and the bolt 4223 to force the bolt 4223 towards the attachment member 40 and make a first end of the bolt 4223 extend out of the through hole 42. A manipulating portion is formed on a second end of the bolt 4223. Two opposite notches 45 are correspondingly defined in opposite sides of the attachment member 40.

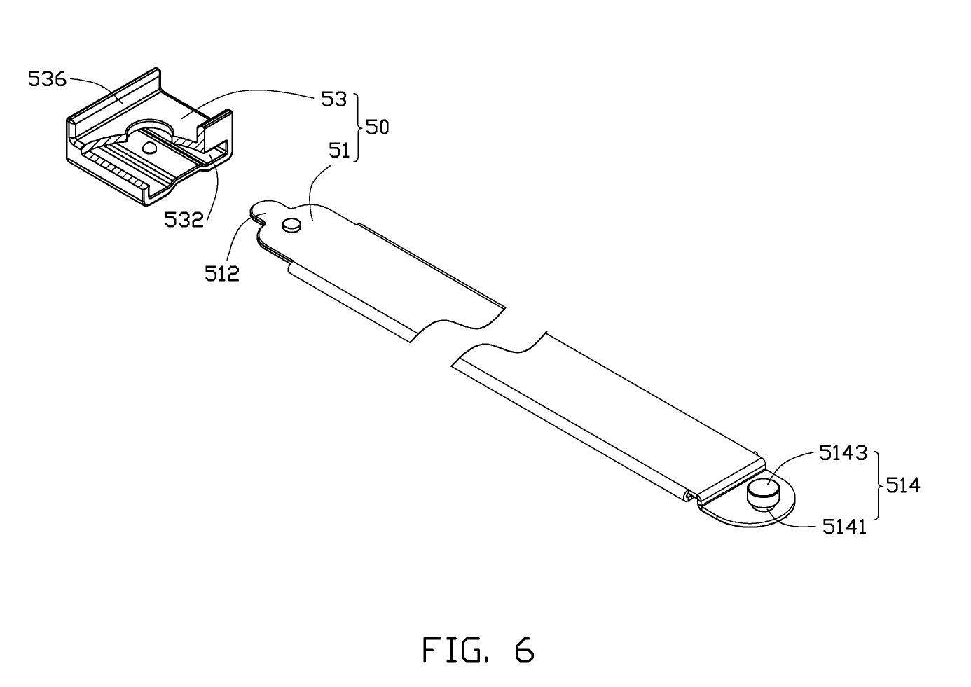

Referring to FIG. 6, the supporting member 50 includes a supporting rail 51 and a blocking piece 53. A coupling post 514 extends upwards from the supporting rail 51 adjacent to a first end of the supporting rail 51. The coupling post 514 includes a neck portion 5141 engaging the supporting rail 51, and a head portion 5143 of a diameter exceeding that of the neck portion 5141, extending therefrom. The supporting rail 51 forms an engaging tongue 512 at a second end of the supporting rail 51. The blocking piece 53 defines a sliding slot 532 running there though. A bulge 534 extends upwards from a bottom wall bounding the sliding slot 532. Two opposite blocking portions 536 extend upwards from a top of the blocking piece 53 adjacent to opposite openings of the sliding slot 532, correspondingly.

Referring to FIGS. 1-8, in assembly, the first mounting bracket 20 pivotally connects to the second end of the first arm segment 12, with a pin 61 pivotally passing through the pivoting portion 121 of the first arm segment 12, and opposite ends of the pin 61 fixed to the corresponding pivot holes 232 of the first mounting bracket 20. The attachment member 40 pivotally connects to the second end of the second arm segment 14, with a pin 62 pivotally passing through the pivoting portion 141 of the second arm segment 14, and the pivoting portion 41 of the attachment member 40. The first mounting bracket 20 and the attachment member 40 are correspondingly coupled to the first rail 710 and the second rail 730 of one of the opposite slide assemblies 700 as follows. The first mounting bracket 20 is received in the first rail 710 from the rear of the first rail 710, until the bolt 2123 of the engaging button 212 is received in the locking hole 711 of the first rail 710. At the same time, the insert 213 of the first mounting bracket 20 extends into the retaining gap 715 of the first rail 710, and the strip 713 of the first rail 710 is received in the cutouts 211. The opposite notches 45 of attachment member 40 correspondingly align with the guiding blocks 735 of the fixing plate 731 of the second rail 730, to enable the attachment member 40 to be received in the guiding slot 736 of the fixing plate 731 of the second rail 730. The attachment member 40 slides rearwards from the second rail 730, until the bolt 4223 is received in the locking hole 733 of the fixing plate 731. Accordingly, the attachment member 40 is secured to the fixing plate 731. The second mounting bracket 30 is received in the first rail 710 of the other slide assembly 700 from the rear of the first rail 710 until the bolt 3123 of the engaging button 312 is received in the locking hole 711 of the first rail 710. At the same time, the insert 313 of the second mounting bracket 30 extends into the retaining gap 715 of the first rail 710, and the strip 713 of the first rail 710 is received in the cutouts 311.

The blocking piece 53 is slidably mounted to the supporting rail 51, with the supporting rail 51 passing through the sliding slot 532 thereof. The bulge 534 abuts the supporting rail 51 to provide a friction force to prevent sliding of the blocking piece 53, unless a driving force is sufficient to overcome the friction force. The engaging tongue 512 is received in the slot 333 of the flange 33 at the bottom of the second mounting bracket 30. The coupling post 514 passes through the coupling hole 234 of the flange 23 at the bottom of the first mounting bracket 20, with the head portion 5143 of the coupling post 514 aligned with the access portion 2341 of the coupling hole 234. The supporting rail 51 is manipulated such that the neck portion 5141 is received in the retaining portion 2343 of the coupling hole 234. Thus, the first end and the second end of the supporting rail 51 are correspondingly connected to the opposite slide assemblies 700. The supporting rail 51 is angled relative to the extension direction of the sliding assemblies 700, with the first end of the supporting rail 51 arranged at the front of the second end of the supporting rail 51.

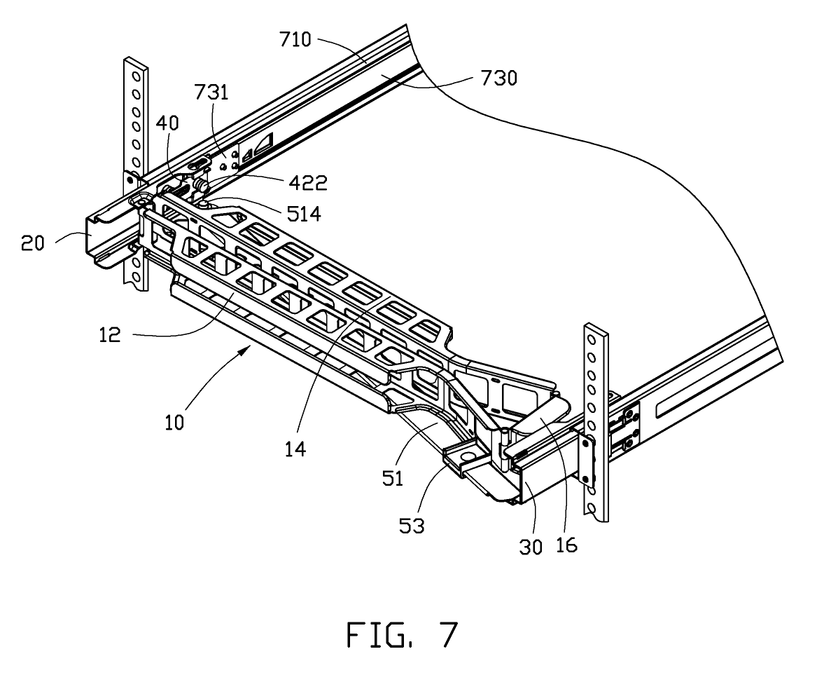

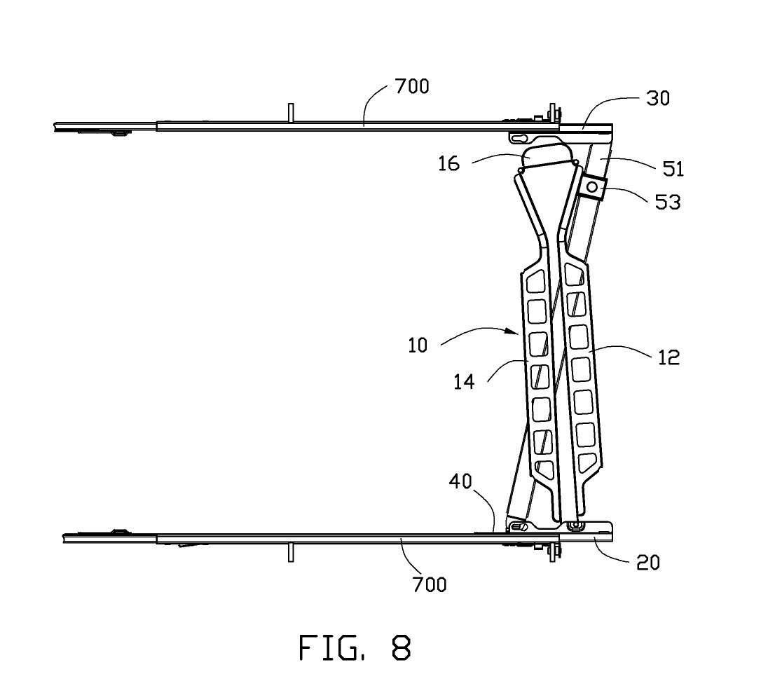

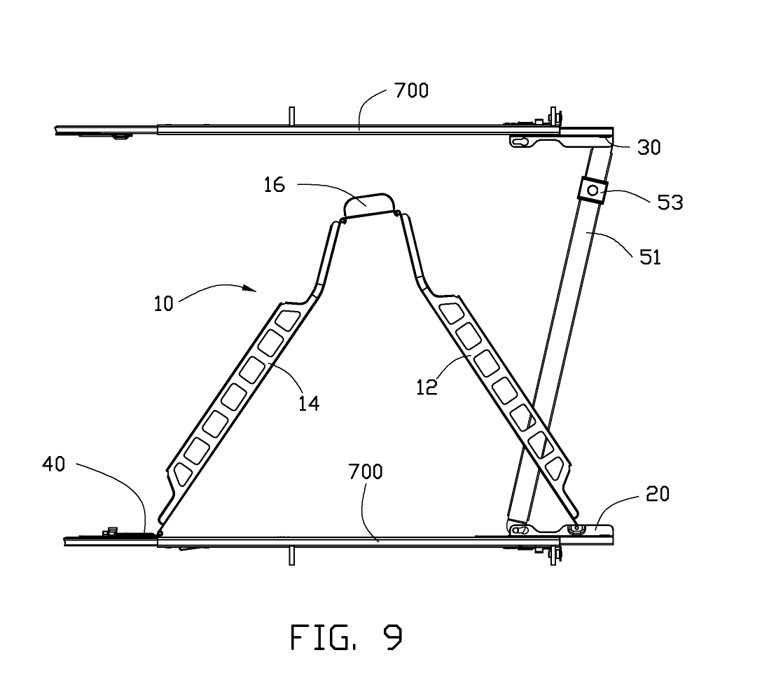

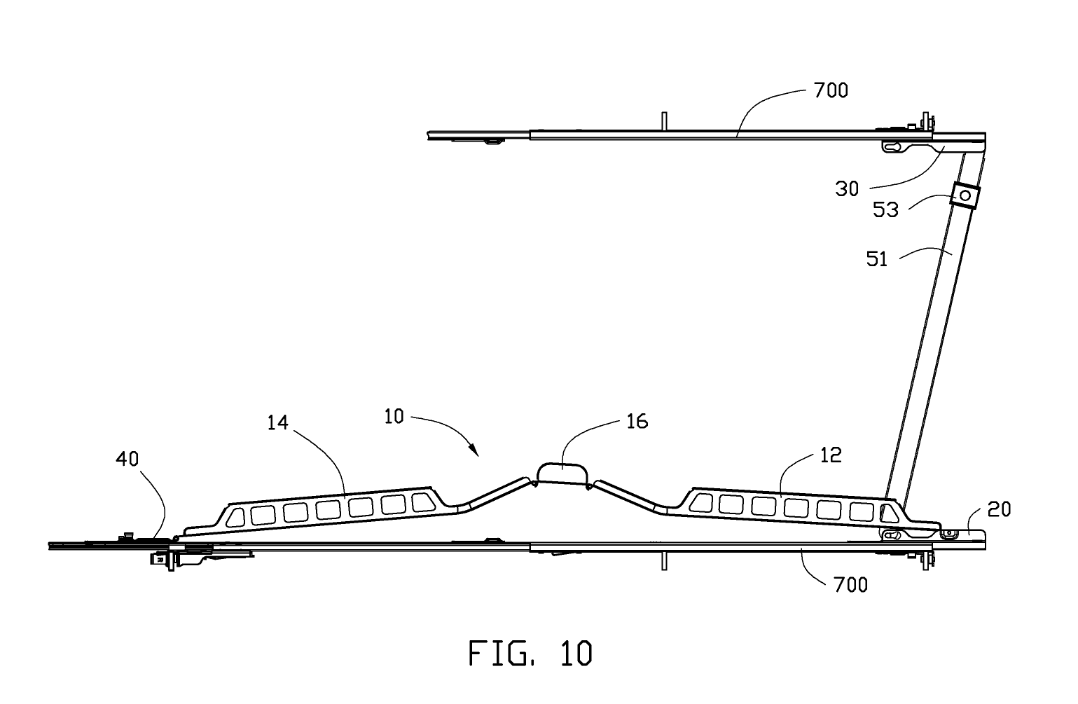

Referring to FIGS. 7-10, in use, the second end of the second arm segment 14 moves with the second rail 730 relative to the first rail 710, positioning the arm assembly 10 between spreading where the second end of the second arm segment 14 moves away from the second end of the first arm segment 12, and collapsing where the first and second arm segments 12 and 14 are juxtaposition. The supporting rail 51 is disposed under and supporting the arm assembly 10 when both spreading and collapsed. The arm assembly 10 is prevented from sagging. When the arm assembly 10 is folded as shown in FIG. 8, the blocking piece 53 is slid along the sliding rail 51 until one of the blocking portions 536 abuts the arm assembly 10. Therefore, the arm assembly 10 is prevented from swinging rearwards and interfering with rear structures of the equipment rack.

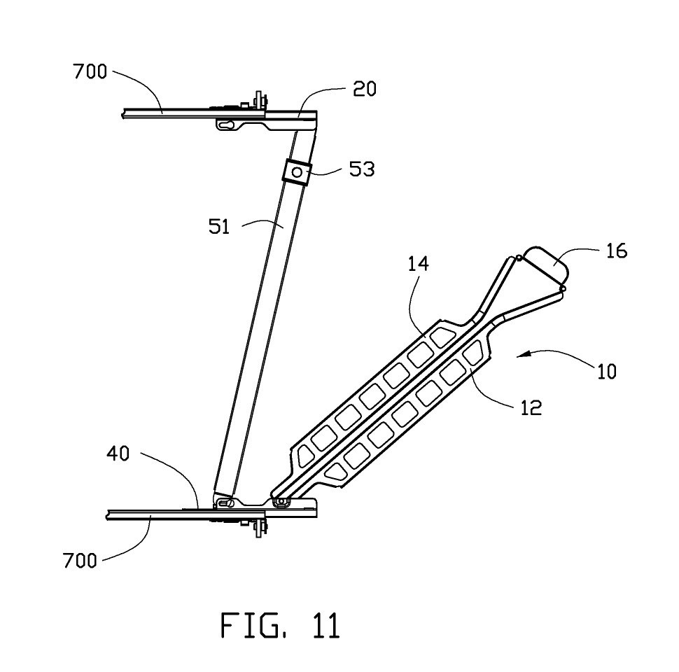

Referring to FIG. 11, when the electronic device is to be maintained from the rear, connecting member 16 is lifted to tilt the arm assembly 10 over the blocking portions 536 of the blocking piece 53. The arm assembly 10 is swung rearwards to provide a space for the maintenance of the electronic device.

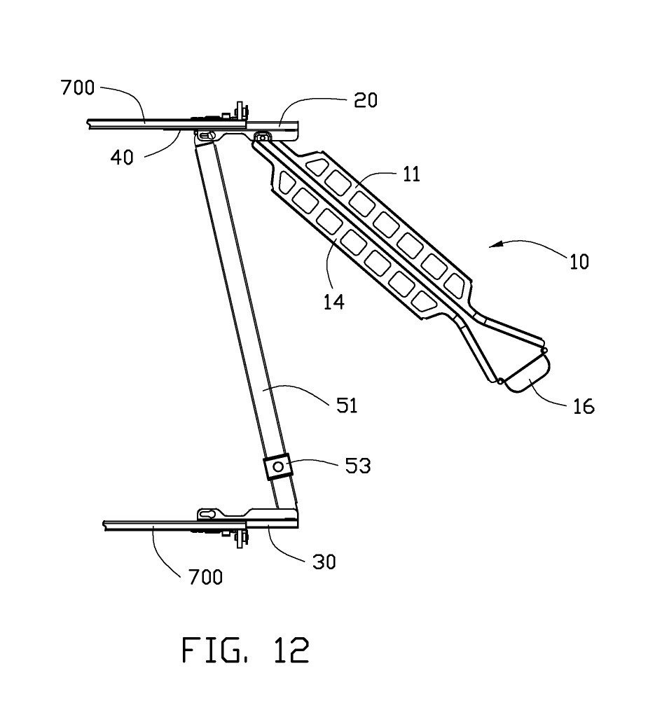

Referring to FIGS. 11 and 12, since the two coupling holes 234 are symmetrically defined in the opposite flanges 23 of the first mounting bracket 20, and the two slots 333 are symmetrically defined in opposite flanges 33 of the second mounting bracket 30, by interchanging mounting positions of the first mounting bracket 20 and the second mounting bracket 30, the mounting orientation can be changed conveniently, to enable the arm assembly 10 to swing to open clockwise or counterclockwise, selectively.

It is believed that the present embodiment and its advantages will be understood from the foregoing description, and it will be apparent that various changes may be made thereto without departing from the spirit and scope of the description or sacrificing all of its material advantages, the examples hereinbefore described merely being exemplary embodiments.

What is claimed is:

1. A cable management apparatus disposed between a first slide assembly and a second slide assembly opposite to the first slide assembly, each of the first slide assembly and the second slide assembly comprising a first rail and a second rail slidably coupled to the first rail to extending from a front end of the first rail, the cable management apparatus comprising:
a foldable arm assembly with opposite ends correspondingly connected to the first rail and the second rail of the first slide assembly, the arm assembly being spreadable with extension of the first slide assembly; and
a supporting member comprising a supporting rail with a first end connected to the first rail of the first slide assembly, and a second end connected to the first rail of the second slide assembly;
wherein the supporting rail is disposed under the arm assembly to support the arm assembly, and angled relative to the extension direction of the first slide assembly, with the first end of the supporting rail arranged at the front of the second end of the supporting rail.

2. The cable management apparatus of claim 1, wherein the arm assembly comprises a first arm segment, a second arm segment, and a connecting member connected between the first arm segment and the second arm segment and pivotal relative to the first arm segment and the second arm segment.

3. The cable management apparatus of claim 2, further comprising a first mounting bracket attached to the first rail of the first slide assembly, and an attachment member attached to the second rail of the first slide assembly, wherein the first mounting bracket pivotally connects to the second end of the first arm segment, and the attachment member is pivotally connected to the second end of the second arm segment.

4. The cable management apparatus of claim 3, further comprising a second mounting bracket attached to the first rail of the second slide assembly, wherein the first end of the supporting rail is connected to the first rail of the first slide assembly via an engagement between the first end of the supporting rail and the first mounting bracket, the second end of the supporting rail is connected to the first rail of the first slide assembly via an engagement between the second end of the supporting rail and the second mounting bracket.

5. The cable management apparatus of claim 4, wherein the first mounting bracket defines at least one coupling hole adjacent to a front end of the first mounting bracket, the second mounting bracket defines at least one slot adjacent to a rear of the second mounting bracket, a coupling post extends from the first end of the supporting rail and is received in one of the at least one coupling holes of the first mounting bracket, the supporting rail forms an inserting tongue at the second end and is received in one of the at least one slot of the second mounting bracket.

6. The cable management apparatus of claim 5, wherein the first mounting bracket comprises a sidewall and a flange extending from a side of the sidewall, the at least one coupling hole comprises one coupling hole defined in the flange of the first mounting bracket, the second mounting bracket comprises a sidewall and a flange extending from a side of the sidewall, and the at least one slot comprises one slot defined in the flange of the second mounting bracket.

7. The cable management apparatus of claim 5, wherein the first mounting bracket comprises a sidewall and two flanges extending from opposite sides of the sidewall, the at least one coupling hole comprises two coupling holes defined in the two flanges of the first mounting bracket, the second mounting bracket comprises a sidewall and two flanges extending from opposite sides of the sidewall, and the at least one slot comprises two slots defined in the two flanges of the second mounting bracket.

8. The cable management apparatus of claim 5, wherein each of the coupling holes comprises an access portion and a retaining portion communicating with the access portion, wherein width of the access portion exceeds that of the retaining portion, the coupling post comprises a neck portion with a diameter less than that of the retaining portion of the coupling hole, and a head portion with a diameter between the widths of the access portion and the retaining portion of the coupling hole.

9. The cable management apparatus of claim 4, wherein an engaging button is mounted to each of the first mounting bracket and the second mounting bracket, and received in the first rails of the corresponding first and second slide assembly.

10. The cable management apparatus of claim 1, wherein the supporting member further comprises a blocking piece slidably mounted in the supporting rail, abutting the arm assembly and preventing the arm assembly from swinging rearwards.
